(19) United States
(12) Patent Application Publication
(10) Pub. No.: US 2003/0096888 A1
(43) Pub. Date: May 22, 2003

(54) Polymer grafted carbon black primarily for use in positive thermal coefficient over-current protection devices

(76) Inventors: Farhad Adib, Aliso Viejo, CA (US); Chechian Ko, Taipei (TW); Guojun Liu, Calgary (CA); Zengrong Zhang, Calgary (CA)

Correspondence Address: Howard J. Klein, KLEIN, O'NEILL & SINGH, 2 Park Plaza, Suite 510, Irvine, CA, 92614, US

(21) Appl. No.: 09/988,967

(22) Filed: Nov. 16, 2001

(51) Int. Cl. C08J 3/00

(52) U.S. Cl. 523/205; 524/315; 524/378

(57) ABSTRACT

A composite material highly suitable for use in over-current protection devices comprising a semi-crystalline polymer which has in its matrix finely dispersed carbon black material that has been chemically reacted with a grafting agent, and has the grafting agent covalently attached to the carbon black. The grafting agent includes a lipophilic portion or moiety that renders the carbon black linked to the grafting agent highly compatible with the polymer matrix. The auto thermal height (ATH) of the composite materials is significantly enhanced and a slight positive temperature coefficient is still observed with rising temperature after the transition temperature of the composite material has been reached.

### BACKGROUND OF THE INVENTION

1. Field of the Invention

The present invention relates to carbon black material covalently bonded to a grafting agent which renders the carbon black more compatible for dispersion in semi-crystalline polymers, and which when dispersed in the polymer provides improved material for positive temperature coefficient over-current protection devices. More specifically, the present invention relates to carbon black reacted with and covalently bonded with a grafting agent, dispersed in semi-crystalline polyethylene, and to positive temperature coefficient over-current protection devices which comprise such material.

2. Brief Description of Background Art

Materials which exhibit increased electrical resistance with increasing temperature are known in the art. Particularly, materials consisting essentially of a polyethylene (PE) matrix and including a relatively large percentage of carbon black exhibit such “positive temperature coefficient” (PTC), and are widely used in the art in over-current protection devices. These devices, comprising polyethylene-carbon-black composites, function because after reaching a critical or “trip temperature” the electrical resistivity of the device increases sharply, resulting in virtual cessation of current flow through the device, and thus protection from over-current. After cooling below the “trip temperature”, the resistivity of the device decreases sharply, so that the electric circuit which has been “switched off” by the protective device is “switched on” again. A description of the basic functioning of such over-current protection devices comprising polyethylene-carbon-black composites can be found, for example, in Raychem Product Design & Development News, October, 1991.

However, after reaching a maximum on a positive temperature coefficient “slope”, the resistivity of state of the art polyethylene-carbon-black composite materials normally decreases with further rise of temperature. This is illustrated in FIG. 1 of the appended drawings which depicts the temperature dependence of the electric resistivity of traditional PE/carbon black composites. This negative temperature coefficient (NTC) effect arises due to the redistribution of carbon black particles (CB) inside the melted polyethylene (PE) to re-establish particle-particle contacts. In accordance with some prior art this thermal instability problem of PTC devices can be alleviated by cross-linking the PE matrix (see for example, Narkis, M.; Ram, A.; Stein, Z. J. Appl. Sci. 1980, 25, 1515 and Yang G. Polym. Compos. 1997, 18, 484) or by or by using PE modified with ˜1% (molar) maleic anhydride as the polymer matrix for the carbon black (CB). According to the best knowledge of the present inventors a description of PE modified with ˜1% (molar) maleic anhydride as the polymer matrix has not been published.

A publication by N. Tsubokawa titled “CARBON BLACK (Graft Copolymers) 1996 by CRC Press, Inc. describes the possible reactive groups on the surface of carbon black, and summarizes the chemical reactions which may occur with various reagents and involving these functional groups, thereby allowing the covalent bonding or “grafting” of materials to carbon black.

Thus, it has been and continues to be a goal in the state-of-the-art to obtain positive temperature coefficient materials, primarily for use in over-current protection devices, which have improved thermal stability, increased resistance above the trip temperature for a given carbon loading, and do not exhibit a negative temperature coefficient after reaching a maximum resistivity. The present invention is a significant accomplishment in achieving this goal.

### SUMMARY OF THE INVENTION

The present invention relates to a composite material comprising a semi-crystalline polymer which has in its matrix finely dispersed carbon black material that has been chemically reacted with a grafting agent, and has the grafting agent covalently attached to the carbon black. The grafting agent includes a lipophilic portion or moiety that renders the carbon black linked to the grafting agent highly compatible with the polymer matrix. Surprisingly, the auto thermal height (ATH) of the composite materials of the invention is significantly enhanced. The auto thermal height is the range of resistance between the trip temperature and that temperature (transition temperature) above which the electrical resistivity of the composite material no longer rises sharply with increasing temperature. Moreover, a slight positive temperature coefficient is still observed with rising temperature after the transition temperature has been reached. This is in contrast with comparable prior art composites which exhibit a negative temperature coefficient beyond the transition temperature.

The present invention also relates to the process of preparing the composite materials of the invention, the process comprising the step of thoroughly admixing carbon black, a suitable grafting material or agent having functional groups which can react covalently with available OH or COOH groups on the carbon black, a suitable catalyst to catalyze the reaction between the carbon black and the grafting agent, and a semi-crystalline polymer, the admixing process occurring while the semi-crystalline polymer is in the molten state.

The present invention also relates to over-current protection devices which incorporate the novel composite materials of the invention.

### BRIEF DESCRIPTION OF THE DRAWING FIGURES

FIG. 1 is a graph showing the electrical resistivity versus temperature curve of state-of-the-art polyethylene-carbon-black composite materials used in PTC over-current protection devices.

FIG. 2 is a graph showing the electrical resistivity versus temperature curve of one specific embodiment of the polyethylene-carbon-black composite material of the invention.

FIG. 3 is a graph showing the electrical resistivity versus temperature curve of another specific embodiment of the polyethylene-carbon-black composite material of the invention.

### DETAILED DESCRIPTION OF THE INVENTION

The following specification taken in conjunction with the drawings sets forth the preferred embodiments of the present invention. The embodiments of the invention disclosed herein are the best modes contemplated by the inventors for carrying out their invention in a commercial environment, although it should be understood that various modifications can be accomplished within the parameters of the present invention.

In accordance with the present invention carbon black material is reacted with a grafting agent in the presence of a catalyst while thoroughly admixed with a semi-crystalline polymer in its molten state, to provide a polymer-carbon-black composite where the carbon black has the grafting agent covalently attached. The resulting composite has a heightened ATH and improved positive temperature coefficient characteristics, and therefore provides over-current protection devices of improved characteristics.

The carbon black used in accordance with the present invention is of the same type which is used to manufacture state-of-the-art over-current protection devices, and specifically to manufacture polyethylene-carbon-black composites used in such devices. Such carbon black is available commercially. It is known that carbon black includes unreacted (free) phenolic hydroxyl groups, and also unreacted (free) carboxylic acid groups on its surface. It is known, as is described in the above cited publication by Tsubokawa, that these groups are available, under the right conditions, for chemical reactions with reagents having functional groups capable of reacting with the phenolic hydroxyl or carboxylic acid groups, respectively. Formula 1 illustrates carbon black having phenolic hydroxyl groups on its surface, and Formula 2 illustrates carbon black having a carboxyl group (such as a “benzoic acid” moiety) on its surface. Although the formulas illustrate only one such functional group, it is known, of course, that carbon black has numerous such groups, essentially randomly distributed, on its surface. In these formulas the solid black circle represents the carbon black “back-bone”

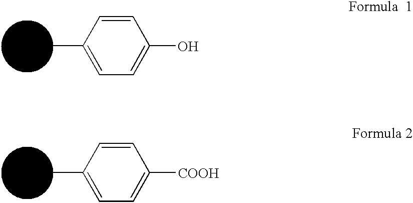

The grafting agent which is used in accordance with the invention is itself a polymer, having a functional group that is capable of reacting either with the phenolic hydroxyl or with the carboxylic acid functionality of the carbon black. The polymeric grafting agent also must have a matrix or “back-bone” that is lipophilic and compatible with the semi-crystalline polymer that provides the matrix for the carbon black dispersed in it to form the composite material of the invention. An epoxide or oxirane group attached to the polymeric grafting agent is eminently suitable for reacting with the phenolic hydroxyl group of the carbon black, as is indicated in Reaction 1 below. A hydroxyl (OH) group attached to the polymeric grafting agent is also suitable for reacting with the carboxyl group of the carbon black, as is indicated in Reaction 2 below. In these reactions the unfilled circle represents the “back-bone” of the polymeric grafting agent.

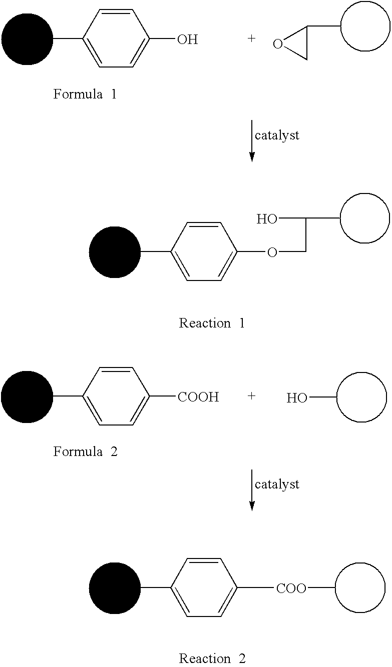

The presently preferred grafting agent is poly(ethylene-co-glycidyl methacrylate) (PE-PGMA) the structure of which is shown by Formula 3 where x represents molar fraction and is in the range of 0.005 to 0.10, more preferably in the range of 0.01 and 0.08 and still more preferably in the range of 0.02 and 0.06. The numeral n is in the range of 50 to 5000, more preferably in the range of 100 to 2000.

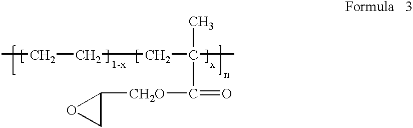

It will be readily understood by those skilled in the art that the numerals x and n reflect the state of polymerization of the grafting agent.

Other grafting agents suitable for use in the present invention are other polymers or copolymers having a lipophilic “back-bone”, and which include epoxy groups for reaction with the phenolic hydroxyl of carbon black (as shown in Reaction 1), or which include hydroxyl groups to react with the carboxylic acid groups of carbon black (as shown in Reaction 2). Examples of grafting agents which can react in accordance with Reaction 1 are polybutenes monoepoxide, and poly(propylene glycol) diglycidyl ether. Examples of grafting agents which have a hydroxyl group and react with carbon black in accordance with Reaction 2 are poly(ethylene glycol) and polyethylene monoalcohol. Still other possible grafting agents are polymers or copolymers which, having a back bone compatible with the semi-crystalline polymer matrix of the material in which the carbon black is dispensed, also have a reactive group that is capable of reacting with carbon black in accordance with the chemical reactions not specifically mentioned here but described in the N. Tsubokawa “CARBON BLACK (Graft Copolymers) 1996 by CRC Press, Inc. publication, which is expressly incorporated herein by reference.

The presently preferred catalyst used in the reaction of covalently binding the grafting agent with epoxide or oxirane groups to carbon black (Reaction 1) is ethyl triphenyl phosphonium bromide. There are many other catalyst suitable for catalyzing this reaction, including other alkyl triphenylphosphonium halides (alkyl may have 1 to 20 carbons) and the halide is Fl, Cl, Br, or I. The catalyst can also be an aliphatic amine of sufficiently high boiling point, that is a boiling point above approximately 180° C., of the structure N—(R)₂ where R is an alkyl group independently selected from any saturated hydrocarbon group having 1 to 20 carbons. Boiling point above approximately 180° C. is necessary so that the catalyst is not effectively distilled out from the reaction that occurs while the carbon black, catalyst and grafting agent are mixed with the molten semi-crystalline polymer of the matrix.

Catalyst for the reaction between carbon black and the grafting agent in accordance with Reaction 2 are catalyst of such type which normally catalyze or promote ester formation, and are otherwise compatible with the reaction conditions. Dicyclohexylcarbodiimide (DCC) is an example.

A preferred example of the semi-crystalline polymer which serves as a matrix is polyethylene of the type which is normally used in the state of the art to manufacture PTC over-current protection devices. Other suitable polymers are polyamides, polyesters, polystyrene, polyacrylates, polymethacrylates, polydienes, and copolymers of these materials.

The composite of the invention may contain additional substances, such as fillers, for example magnesium hydroxide (Mg(OH)₂), magnesium oxide (MgO), and/or zinc oxide (ZnO).

The novel composite of the present invention is prepared in the molten state of the matrix polymer (such as polyethylene) in a container where the molten polymer, the carbon black, the catalyst and the grafting agent are thoroughly admixed by appropriate agitation. In this connection it is noted that admixing carbon black with molten semi-crystalline polymer, and specifically with polyethylene to manufacture PTC composites for over-current protection devices is per se known in the art, and the composite of the present invention is manufactured in similar equipment under similar conditions. The reaction between the carbon black and the grafting agent, and the dispersion in the matrix polymer of carbon black covalently bonded to the grafting agent occur during this mixing. Prior art polyethylene (or other semi-crystalline polymer) and carbon black composites for use in over-current protection devices have a relatively wide range of percentage of carbon black contained in the composite. It is known that the percentage of carbon black in the composite significantly influences its pertinent characteristics. Similarly, the amount of carbon black in the composite of the present invention may be in a relatively wide range. Generally speaking, the composite of the invention comprises the above-described materials in the following ranges. (All percentages are by weight). It will be readily understood by those skilled in the art that the term “grafting agent” is to be taken in the context depending on whether the “grafting agent” is considered before reaction with the carbon black, or after its reaction with the carbon black. It will be readily understood by those skilled in the art, that after reaction with the carbon black the grafting agent no longer has the reactive group because it has reacted with the carbon black to form a bond therewith. Where applicable the reacted grafting agent may be referred to in this description and claims as the “radical” of the grafting agent, meaning the grafting agent already covalently bonded to the carbon black. Nevertheless the differences in weight percentages are insignificant between the reactive grafting agent that is used in the process of the invention to make the positive temperature coefficient composite of the invention and the grafting agent (radical) already incorporated by covalent bonds into the composite. Thus, the weight percentages are as follows:

High density polyethylene (HPDE) or other semi-crystalline polymer: 40-65%;

Carbon black: 30-60%;

Poly(ethylene-co-glycidyl methacrylate) (PE-PGMA) or other grafting agent 1-20%, and

Ethyl triphenyl phosphonium bromide, or other catalyst: 0.01-5%.

A preferred range of these components is as follows.

High density polyethylene (HPDE) or other semi-crystalline polymer :45-60%;

Carbon black:40-60%;

Poly(ethylene-co-glycidyl methacrylate) (PE-PGMA) or other grafting agent 2-10%, and

Ethyl triphenyl phosphonium bromide, or other catalyst,: 0.1-4%.

A still more preferred range of these components is as follows.

High density polyethylene (HPDE) or other semi-crystalline polymer: 45-55%;

Carbon black: 40-55%;

Poly(ethylene-co-glycidyl methacrylate) (PE-PGMA) or other grafting agent3-6%, and

Ethyl triphenyl phosphonium bromide, or other catalyst,: 0.1-2%.

For the manufacture of PTC over-current protection devices the composites of the invention are pelletized and extruded into sheets. The over-current protection devices are manufactured from these sheets substantially in the same manner as over-current protection devices are manufactured from prior art high-density-polyethyle-carbon-black (or the like) composite materials, as this is described for example in U.S. Pat. Nos. 5,849,137 and 5,802,709, the specifications of which are incorporated herein by reference.

It should be understood in connection with the herein listed ranges of percentages of the components, that it is not contemplated within the scope of the invention to have all or most of the ingredients present in their respective maximum listed range in any given composition, as such a composition would be incapable of existence for having more than 100% of the sum of its components. Rather, it is contemplated that when one or more ingredients are in their maximum range, then the ratios of other components are in less than their maximum range, so that the sum total of all components is 100%.

### SPECIFIC EXAMPLE

### Example 1

This is an actual example of preparing a prior art high-density-polyethylene-carbon black composite, for the purpose of comparing its resistivity versus temperature characteristics with the composites of the invention.

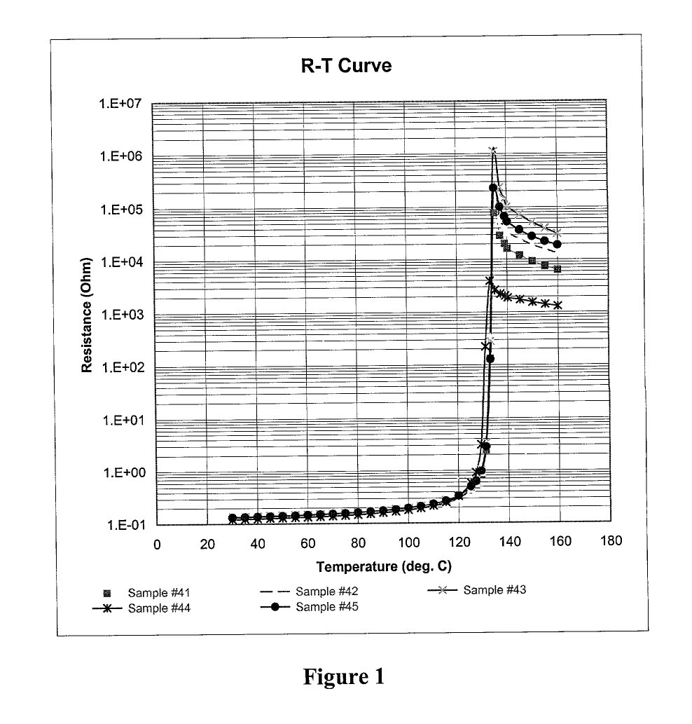

A mixture containing 54% by weight of high density polyethylene (HDPE) purchased from from Equistar Co with a melt index ˜0.2 and having the designation LB 8320, and 46% carbon black purchased from Tokai Co with average particle size around 62 nm and having the designation GSVH, were melt mixed in a 3-liter Banbury mixer for 5 minutes at 50 rpm rotor speed. The temperature during the mixing was approximately in the range of 150 to 240° C. After the mixing, the product was pelletized and extruded into a laminated sheet with a thickness around 0.5 mm. The sheets were then punched into a 8-mm diameter disk for resistivity versus temperature (RT) tests. Six tests were performed and the results of these tests are shown in FIG. 1. It can be seen that the transition temperature on the rapidly rising slope of this state-of-the-art product is between 130 and 140° C. with resistivity in the approximate range of 10³ to 10⁶ ohms at this temperature. The resistivity versus temperature curve shows a negative temperature coefficient after this temperature.

### Example 2 (of the Invention)

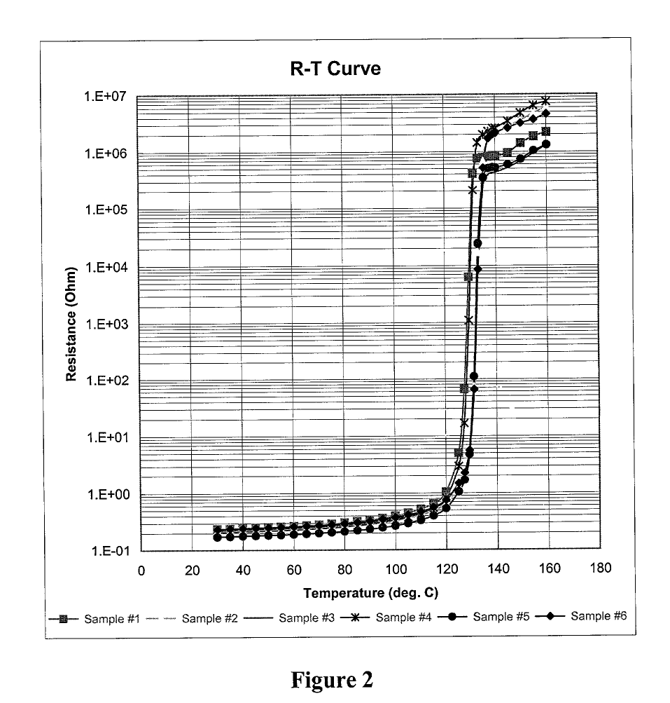

A mixture containing 47.5% by weight of high density polyethylene (HDPE) purchased from from Equistar Co with a melt index ˜0.2 and having the designation LB 8320, 48% carbon black purchased from Tokai Co with average particle size around 62 nm and having the designation GSVH, 4% poly(ethylene-co-glycidyl methacrylate) (PE-PGMA) grafting agent and 0.5% ethyl triphenyl phosphonium bromide (ETPB) catalyst were melt mixed in a 3-liter Banbury mixer for 5 minutes at 50 rpm rotor speed. The PE-PGMA and ETPB materials were obtained from Aldrich Chemical Co. The temperature during the mixing was approximately in the range of 150 to 240° C. After the mixing, the product was pelletized and extruded into a laminated sheet with a thickness around 0.5 mm. The sheets were then punched into a 8-mm diameter disk for resistivity versus temperature (RT) tests. Six tests were performed and the results of these test are shown in FIG. 2. It can be seen that the transition temperature on the rapidly rising slope of this novel product is between 130 and 140° C., and surprisingly with resistivity in the approximate range of 10⁵ to 10⁷ ohms at this temperature. Also surprisingly, the resistivity versus temperature curve shows a positive temperature coefficient after this temperature.

### Example 3 (of the Invention)

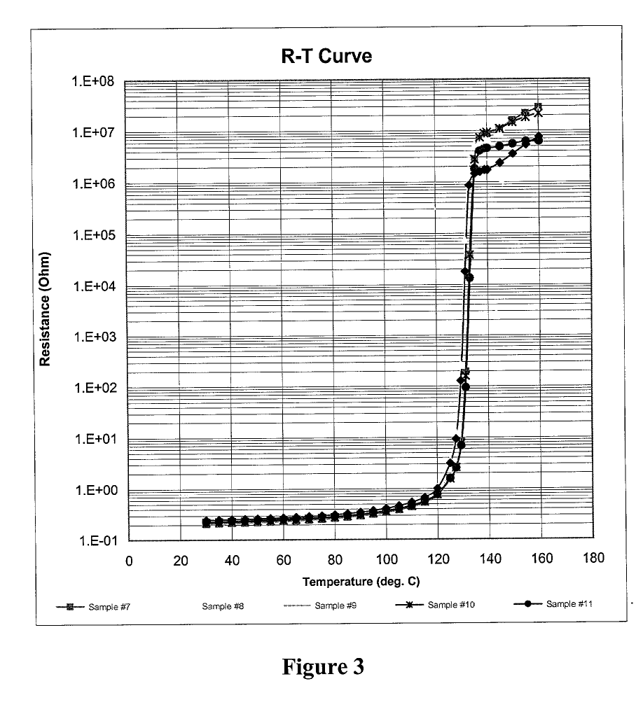

A mixture containing 43.5% by weight of high density polyethylene (HDPE) purchased from from Equistar Co with a melt index ˜0.2 and having the designation LB 8320, 48% carbon black purchased from Tokai Co with average particle size around 62 nm and having the designation GSVH, 4% poly(ethylene-co-glycidyl methacrylate) (PE-PGMA) grafting agent, 0.5% ethyl triphenyl phosphonium bromide (ETPB) catalyst and 4% magnesium hydroxide (Mg(OH)₂ were melt mixed in a 3-liter Banbury mixer for 5 minutes at 50 rpm rotor speed. The PE-PGMA and ETPB materials were obtained from Aldrich Chemical Co. The temperature during the mixing was approximately in the range of 150 to 240° C. After the mixing, the product was pelletized and extruded into a laminated sheet with a thickness around 0.5 mm. The sheets were then punched into a 8-mm diameter disk for resistivity versus temperature (RT) tests. Six tests were performed and the results of these tests are shown in FIG. 3. It can be seen that the transition temperature on the rapidly rising slope of this novel product is between 130 and 140° C., and surprisingly with resistivity in the approximate range of 10⁶ to 10⁷ ohms at this temperature. Also surprisingly, the resistivity versus temperature curve shows a positive temperature coefficient after this temperature.

It is also apparent from the foregoing data that grafting of the polymer material to the carbon black increases the resistivity of the composite relative to the same ungrafted composite with the same carbon loading.

What is claimed is:

1. A composite material comprising:
a semi-crystalline polymer forming a matrix;
carbon black finely dispersed in said matrix, and
a polymeric grafting agent covalently attached to the carbon black, the grafting agent having a lipophilic backbone moiety thereby rendering the grafting agent and the dispersed carbon black compatible with the matrix of the semi-crystalline polymer.

2. A composite material in accordance with claim 1 wherein the semi-crystalline polymer is selected from the group consisting of polyethylene, polyamides, polyesters, polystyrene, polyacrylates, polymethacrylates, polydienes, and copolymers of the above-listed polymers.

3. A composite material in accordance with claim 2 wherein the crystalline polymer is high density polyethylene.

4. A composite material in accordance with claim 1 wherein the grafting agent and the attached carbon black have the formula 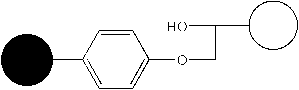
where the solid black circle represents the backbone of the carbon black and the unfilled circle represents the lipophilic backbone of the grafting agent.

5. A composite material in accordance with claim 1 wherein the grafting agent and the attached carbon black have the formula 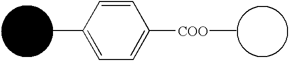
where the solid black circle represents the backbone of the carbon black and the unfilled circle represents the lipophilic backbone of the grafting agent.

6. A composite material in accordance with claim 1 additionally comprising a filler.

7. A composite material in accordance with claim 6 where the filler is selected from the group consisting of magnesium hydroxide (Mg(OH)₂), magnesium oxide (MgO), and zinc oxide (ZnO).

8. A composite material in accordance with claim 4 comprising:
40 to 65% by weight of semi-crystalline polymer;
30 to 60% by weight of carbon black;
1 to 20% by weight of grafting agent, and
0.01 to 5% by weight of residue of a catalyst that has catalyzed a reaction covalently attaching the grafting agent to the carbon black, said percentages being selected such that the total percentage of the components does not exceed 100%.

9. A composite material in accordance with claim 8 wherein the semi-crystalline is high density polyethylene.

10. A composite material in accordance with claim 9 wherein the carbon black and attached grafting agent consists essentially of poly(ethylene-co-glycidyl methacrylate) covalently attached to carbon black.

11. A composite material in accordance with claim 8 comprising:
45 to 60% by weight of semi-crystalline polymer;
40 to 60% by weight of carbon black;
2 to 10% by weight of grafting agent, and
0.1 to 4% by weight of residue of a catalyst that has catalyzed a reaction covalently attaching the grafting agent to the carbon black, said percentages being selected such that the total percentage of the components does not exceed 100%.

12. A composite material in accordance with claim 11 wherein the semi-crystalline polymer is high density polyethylene.

13. A composite material in accordance with claim 12 wherein the carbon black and attached grafting agent consists essentially of poly(ethylene-co-glycidyl methacrylate) covalently attached to carbon black.

14. A composite material in accordance with claim 8 comprising:
45 to 55% by weight of semi-crystalline polymer;
40 to 55% by weight of carbon black;
3 to 6% by weight of grafting agent, and
0.1 to 2% by weight of residue of a catalyst that has catalyzed a reaction covalently attaching the grafting agent to the carbon black, said percentages being selected such that the total percentage of the components does not exceed 100%.

15. A composite material in accordance with claim 14 wherein the semi-crystalline polymer is high density polyethylene.

16. A composite material in accordance with claim 15 wherein the carbon black and attached grafting agent consists essentially of poly(ethylene-co-glycidyl methacrylate) covalently attached to carbon black.

17. An over-current protection device incorporating the composite material in accordance with claim 1 as a positive temperature coefficient material.

18. A composite material exhibiting positive temperature coefficient and suitable for incorporation in an over-current protection device, the composite comprising:
40 to 65% by weight of high density polyethylene;
30 to 60% by weight of carbon black, the carbon black being covalently attached to a grafting agent where the grafting agent is 1 to 20% by weight of the composition, and where the grafting agent is the radical of poly(ethylene-co-glycidyl methacrylate);
0.01 to 5% by weight of residue of ethyl triphenyl phosphonium bromide catalyst that has catalyzed a reaction covalently attaching the grafting agent to the carbon black, said percentages being selected such that the total percentage of the components does not exceed 100%.

19. A composite material in accordance with claim 18 comprising:
45 to 60% by weight of high density polyethylene;
40 to 60% by weight of carbon black, the carbon black being covalently attached to a grafting agent where the grafting agent is 2 to 10% by weight of the composition, and where the grafting agent is the radical of poly(ethylene-co-glycidyl methacrylate);
0.1 to 4% by weight of residue of ethyl triphenyl phosphonium bromide catalyst that has catalyzed a reaction covalently attaching the grafting agent to the carbon black, said percentages being selected such that the total percentage of the components does not exceed 100%.

20. A composite material in accordance with claim 19 comprising:
45 to 55% by weight of high density polyethylene;
40 to 55% by weight of carbon black, the carbon black being covalently attached to a grafting agent where the grafting agent is 3 to 6% by weight of the composition, and where the grafting agent is the radical of poly(ethylene-co-glycidyl methacrylate);
0.1 to 2% by weight of residue of ethyl triphenyl phosphonium bromide catalyst that has catalyzed a reaction covalently attaching the grafting agent to the carbon black, said percentages being selected such that the total percentage of the components does not exceed 100%.

21. An over-current protection device incorporating the composite material in accordance with claim 18 as a positive temperature coefficient material.

22. A process for making a composite material having positive temperature coefficient properties, the process comprising the steps of:
intimately admixing a molten semi-crystalline polymer with carbon black and with a polymeric grafting agent and a catalyst, the grafting agent having a functional group that is capable of covalently reacting and bonding to the carbon black and having a lipophilic backbone moiety thereby rendering the grafting agent and the dispersed carbon black compatible with the matrix of the semi-crystalline polymer, the catalyst being capable of catalyzing the reaction of the grafting agent with the carbon black and allowing said reaction between the carbon black and the grafting agent to occur.

23. A process in accordance with claim 22 wherein the semi-crystalline polymer is selected from the group consisting of polyethylene, polyamides, polyesters, polystyrene, polyacrylates, polymethacrylates, polydienes, and copolymers of the above-listed polymers.

24. A process in accordance with claim 23 wherein the semi-crystalline polymer is high density polyethylene.

25. A process in accordance with claim 23 wherein the grafting agent is poly(ethylene-co-glycidyl methacrylate).

26. A process in accordance with claim 23 wherein the catalyst is ethyl triphenyl phosphonium bromide.

27. A process in accordance with claim 23 wherein the intimate admixture is maintained in the temperature range of 150 to 240° C. while the reaction is allowed to occur.

28. An over-current protection device including a composite material having positive temperature coefficient properties, wherein the composite material comprises:
a semi-crystalline polymer forming a matrix;
carbon black finely dispersed in said matrix, and
a polymeric grafting agent covalently attached to the carbon black, the grafting agent having a lipophilic backbone moiety thereby rendering the grafting agent and the dispersed carbon black compatible with the matrix of the semi-crystalline polymer.

29. An over-current protection device in accordance with claim 28 wherein the semi-crystalline polymer is selected from the group consisting of polyethylene, polyamides, polyesters, polystyrene, polyacrylates, polymethacrylates, polydienes, and copolymers of the above-listed polymers.

30. An over-current protection device accordance with claim 29 wherein the crystalline polymer is high density polyethylene.

31. An over-current protection device in accordance with claim 28 wherein the grafting agent and the attached carbon black have the formula 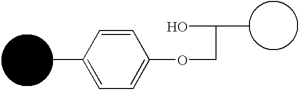
where the solid black circle represents the backbone of the carbon black and the unfilled circle represents the lipophilic backbone of the grafting agent.

32. An over-current protection device in accordance with claim 28 wherein the grafting agent and the attached carbon black have the formula 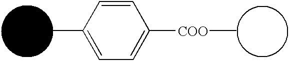
where the solid black circle represents the backbone of the carbon black and the unfilled circle represents the lipophilic backbone of the grafting agent.

33. An over-current protection device in accordance with claim 28 additionally comprising a filler.

34. An over-current protection device in accordance with claim 33 where the filler is selected from the group consisting of magnesium hydroxide (Mg(OH)₂), magnesium oxide (MgO), and zinc oxide (ZnO).

35. An over-current protection device in accordance with claim 31 comprising:
40 to 65% by weight of semi-crystalline polymer;
30 to 60% by weight of carbon black;
1 to 20% by weight of grafting agent, and
0.01 to 5% by weight of residue of a catalyst that has catalyzed a reaction covalently attaching the grafting agent to the carbon black, said percentages being selected such that the total percentage of the components does not exceed 100%.

36. An over-current protection device in accordance with claim 35 wherein the semi-crystalline polymer is high density polyethylene.

37. An over-current protection device in accordance with claim 36 wherein the carbon black and attached grafting agent consists essentially of poly(ethylene-co-glycidyl methacrylate) covalently attached to carbon black.
